(19) United States
(12) Patent Application Publication
(10) Pub. No.: US 2025/0050670 A1
(43) Pub. Date: Feb. 13, 2025

(54) DIRECT TO SUBSTRATE PRINTING ASSEMBLY, METHODS OF USE THEREOF AND COMPOSITIONS PRODUCED THEREBY

(71) Applicant: EASTERN TECH LLC, Orange, CT (US)

(72) Inventors: Szu-Hao CHO, Orange, CT (US); Gerald Cantalupo, Jr., Toms River, NJ (US); Erienne Murphy, Milford, CT (US); Shawn Liu, Orange, CT (US)

(21) Appl. No.: 18/799,045

(22) Filed: Aug. 9, 2024

Related U.S. Application Data
(60) Provisional application No. 63/518,966, filed on Aug. 11, 2023.

(51) Int. Cl. B41M 5/035; B41M 5/00; B41M 7/00

(52) U.S. Cl. CPC B41M 5/0356; B41M 5/0047; B41M 7/009

(57) ABSTRACT

A direct to substrate printing assembly including a substrate, an ink printing station wherein the ink printing station is configured to print an ink layer onto the substrate, a binder application station wherein the binder application station is configured to dispose a binder onto the ink layer, a curing station, and a transfer station wherein the assembly is configured to transfer the ink layer and the binder layer disposed on the substrate to an article and wherein the assembly is fully automated. A method of direct to substrate printing and a composition for direct to substrate printing produced therefrom are also disclosed.

### CROSS REFERENCE TO RELATED APPLICATION

This application claims priority to and the benefit of U.S. Provisional Patent Application No. 63/518,966, filed Aug. 11, 2023, in the United States Patent and Trademark Office, the content of which in its entirety is hereby incorporated by reference.

### BACKGROUND OF THE INVENTION

### 1. Field of the Invention

This disclosure relates to an assembly for direct to substrate printing, methods of use thereof, and direct to substrate compositions for printing on an article.

### 2. Description of the Related Art

During direct to substrate printing, or “direct to film printing,” colored ink and white ink can be printed on a transfer “film.” The printed inks on the film form an image. The image then can be treated with a powder adhesive, followed by curing of the resultant film/image/adhesive composition. After curing, the film/image/adhesive composition can be cut to size and manually placed onto a material to be printed. The image is then transferred onto the material. After transferring of the image, the transfer film is removed to provide a final printed material.

Drawbacks of direct to film printing can include challenges associated with the transfer film, such as inconsistencies in the film properties, cutting/shaping of the film before image transfer, lack of film reusability, and so forth. Additionally, the use of powder adhesive for direct to film printing increases the complexity of the method of application. Complications associated with the powder adhesive include a messier process, inhalation precautions for technicians, and the use of shakers or vibrating equipment to distribute the powder evenly over an image. Enhanced durability, clarity, and hand feel of transferred images also continue to drive the desire for improvements to direct to film printing processes.

A need remains for efficient methods of printing direct to a substrate and improved binding of the direct to substrate printed image onto an article.

### SUMMARY OF THE INVENTION

In one embodiment, a direct-to-substrate printing assembly including a substrate, an ink printing station wherein the ink printing station is configured to print an ink layer onto the substrate, a binder application station wherein the binder application station is configured to dispose a binder onto the ink layer, a curing station wherein the curing station is configured to cure or partially cure the ink layer and binder layer to provide a cured ink and binder layer or a partially cured ink and binder layer, and a transfer station. The transfer station is configured to transfer the cured ink and the binder layer or the partially cured ink and the binder layer disposed on the substrate to an article and the assembly is fully automated.

In another embodiment, a method of direct to substrate printing includes printing an ink onto a substrate to form an ink layer, disposing a binder onto the ink layer, wherein the substrate with the ink layer and the binder layer forms a composition, curing or partially curing the ink layer and binder layer to provide i) a cured ink layer and a cured binder layer, ii) a partially cured ink layer and a partially cured binder layer, iii) a cured ink layer and a partially cured binder layer, or iv) a partially cured ink layer and a cured binder layer, orienting the partially cured binder layer or the cured binder layer of the composition to face towards an article to be printed and disposing the composition onto the article to be printed, transferring the partially cured ink layer or the cured ink layer and the partially cured binder layer or the cured binder layer onto the article to be printed to provide a printed article, and removing the substrate from the printed article. The substrate is transported automatically throughout the method.

In yet another embodiment, a transferable image composition for direct to substrate printing including a substrate, a printed ink layer of an image to be printed on an article, and a binder layer comprising a jettable binder or a powder adhesive disposed on the printed ink layer.

The above described and other features are exemplified by the following figures and detailed description.

### BRIEF DESCRIPTION OF THE DRAWINGS

Referring now to the figures, which are exemplary embodiments, and wherein the like elements are numbered alike.

FIG. 1 is a depiction of an embodiment of a direct to film printing assembly; and

FIG. 2 is a side view depiction of a transferable image composition.

### DETAILED DESCRIPTION OF THE INVENTION

Disclosed herein is an assembly for direct to substrate printing, methods of use thereof, and compositions produced thereby. The assembly comprises a substrate, an ink printing station, a binder application station, and a transfer station to dispose a printed image onto an article. During use of the assembly, ink is printed onto the substrate to form an ink layer, binder is then disposed onto the ink layer to form a binder layer. The assembly can include a curing station to fully or partially cure the ink layer and/or the binder layer disposed on the ink layer. The substrate, the ink layer, and the binder layer form a transferable image composition. The assembly can be used to manufacture a printed article. The assembly provides a setup to facilitate the transfer of an image via an automated process, which can be operated by one or more operator(s). In some embodiments, the assembly can be operated by a single operator.

A transferable image composition for direct to substrate printing can be manufactured with the automated assembly for direct to substrate printing. The transferable image composition can be directly applied to an article to be printed without off-line processing (e.g., cutting of the composition off the film and manual placement of the composition onto the article to be printed). In some embodiments, the transferable image composition can include layers of “wet” or partially cured ink and/or binder. The partially cured ink and/or binder speed the manufacturing process by decreasing or eliminating cure time. The use of partially cured ink and binder can also improve the quality of the printed article where the ink and binder can more fully integrate into the article surface to increase bonding and durability of the transferred image. Partially cured ink and binder can more fully integrate into an article by wicking action of the article and/or an increase in physical contact between the article and the ink and binder in comparison to fully cured, dry ink and binder.

Further disclosed is a method for direct to substrate printing using an assembly for direct to substrate printing where the printing process is automated and can be performed by one or more operator(s). The method can further include the use of an ink and/or a binder which are not fully cured before transfer of the image to the article. In some embodiments, the binder is a liquid. When a liquid binder is used, the method can reduce technician time associated with the use of powder adhesive and can eliminate the inhalation risk from powder adhesive for the binder. The method of direct to substrate printing can reduce the heat required to cure the ink and/or the binder and can eliminate off-line processing.

“Ambient temperature,” as used herein, refers to the air temperature of the environment surrounding an object, for example, a temperature range of about 15° C. to about 30° C.

“Ambient pressure,” as used herein, refers to the pressure of an environment that surrounds an object, for example, a pressure range of about 90 kilopascals to about 110 kilopascals.

“And/or” includes any and all combinations of one or more of the associated listed items.

“Fully cured,” as used herein, refers to a water content of less than 5 weight percent based on the total weight of the material.

“Partially cured,” as used herein, refers to a water content of 5 weight percent to 95 weight percent based on the total weight of the material.

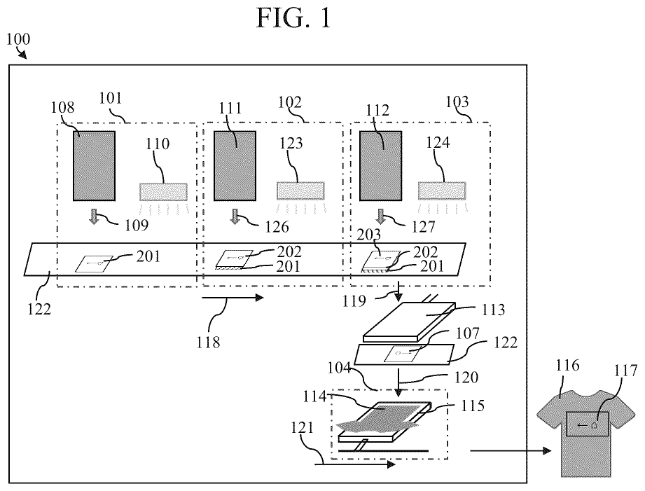

FIG. 1 is an exemplary depiction of a direct to film printing assembly 100 (hereinafter assembly 100) that comprises a color ink printing station 101, a white ink printing station 102, and a binder application station 103. The color ink printing station 101 includes a color ink applicator 108 and a curing element 110. The white ink printing station 102 includes a white ink applicator 111 and a curing element 123. The binder application station 103 includes a binder applicator 112 and a curing element 124. The substrate 122 can serve as the surface for the disposition of ink and binder to form the image 107. The direction of the printing process through the assembly is indicated by the arrows 118, 119, 120, and 121. After preparing the image 107 with color ink 109, white ink 126, and binder 127, the image 107 can be disposed between a first platen 113 and an article 114 oriented on a second platen 115. Within a transfer station 104, the image 107 is transferred onto the article 114. During orientation and placement on article 114, the image 107 can be flipped horizontally or vertically to dispose the binder layer 203 of image 107 onto the article 114. The final printed article 116 contains an image 117 transferred from the image 107.

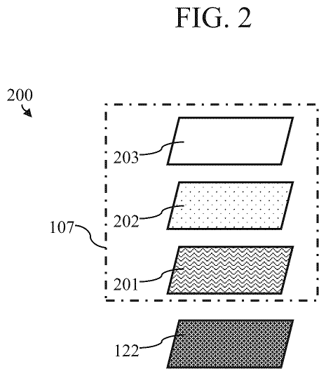

An exemplary embodiment of the transferable image composition 200 (hereinafter composition 200) is depicted in FIG. 2. The composition 200 is the combination of components used to transfer an image 107 to an article 114. Color ink and/or white ink is printed on a substrate 122. After printing of the color ink 109 and/or white ink 126 onto the substrate 122, a binder layer 203 is disposed on the printed ink layer(s) to provide the image 107 for transferring. When both a color ink printed layer 201 and a white ink printed layer 202 are present or when only the white ink printed layer 202 is present, the binder layer 203 is disposed on the white ink printed layer 202. When only the color ink printed layer 201 is present, the binder layer 203 is disposed on the color ink printed layer 201. After manufacture, the composition 200 is ready for transfer onto an article 114 to be printed. The composition 200 is positioned where the binder layer 203 of the composition 200 is disposed onto the article 114. After transfer of the image 107 of the composition 200 onto the article 114, the used substrate 122 is removed from the finished image 117. Transfer of the image 107 onto the article 114 can be performed in the presence of temperatures elevated above ambient temperature and/or under pressures above ambient pressure. In some embodiments, the image 107 transfer onto the article can be accompanied with ultraviolet irradiation of the transfer station, and/or with visible light irradiation of the transfer station. In some embodiments, the ink and/or the binder is crosslinked after disposition of the composition 200 on the article 114.

The assembly 100 can be used for direct to substrate printing processes. The printing stations 101, 102, and 103 can be in individual printing stations. In alternative embodiments, the printing stations can be combined into a single housing. In some embodiments, there is one, two, or three separate printing stations within the assembly 100. Methods of garment delivery to the assembly 100 include carousels, serpentine conveyors, and other suitable methods. The assembly 100 can further include a scanner configured to intake the printing job data before the printing process begins. The printing job data can include a graphic file, print settings, operator instructions, and/or other job details. The label can be a barcode, written instructions, or other code containing the printing job data. Scanning of the label can automate workflow, improve efficiency, and reduce operator errors for the printing process. In some embodiments, the label can be disposed on an article 114 to be printed, on the platen 115 transporting the article 114, or on another suitable object.

The applicators 108, 111, and 112 can be housed together in a single unit, can be housed in two or less units, or provided as three separate applicators units. In some embodiments, there is one, two, or three separate applicator units.

The curing elements 110, 123, and 124 can be combined into a single curing element or provided as separate curing elements. In some embodiments, there is one, two, or three separate curing elements. The curing elements can perform the same type of curing or different types. Suitable curing elements provide curing via direct or indirect infrared irradiation, ultraviolet (UV) irradiation, visible light irradiation, laser heat treatment, or combinations thereof. Heat can be supplied by an electric or a gas-powered heating source. In some embodiments, the color ink 109, the white ink 126, and/or the binder 127 can be fully or partially cured after disposition onto the substrate 122.

The substrate 122 can be a film, a paper, or other material suitable to support the image 107. In some embodiments the substrate 122 can be a roll of material capable of conveying the image 107 through the printing stations and the transfer station. In some embodiments, the substrate 122 can be a sheet of film or paper. On a printing carousel, a film substrate 122 can be rolled through the printing station and/or printing stations to the transfer station 104 to directly apply the image 107 to the article 114.

Suitable films for the substrate 122 include thermoplastic polymers, such as polyethylene terephthalate (PET), polypropylene (PP), and polyvinyl chloride (PVC). The substrate 122 has a release layer and an ink receiving layer. The release layer facilitates the removal of the substrate after application of the image 107 to an article 114. The ink receiving layer serves to provide an ink receptive surface to control ink droplet spread and absorb ink for later transfer to the article 114.

The article 114 to be printed can be a fabric, a paper, a plastic, a polymer, or combinations thereof. Suitable fabrics for printing include cotton, hemp, nylon, polyester, rayon, viscose, and blends thereof.

The color ink 109 can be pigment inks or other ink types suitable to be disposed on the substrate 122. For example, the color ink 109 can be CMYK [cyan, magenta, yellow, and key (black)] inks, six-color inks, and so forth. The color ink 109 (in combination with a binder 127) can be transferred to an article 114 while partially cured, or fully cured. The transfer of “wet” or partially cured ink can facilitate binding of the image 107 to the article. In some embodiments, the color ink 109 includes additives such as defoamers to reduce voids (bubbles) in the liquid ink. In some embodiments, no color ink 109 is disposed on the substrate 122 during the printing process for fully white images.

The white ink 126 can be pigment ink or other suitable ink types to be disposed on the color ink 109 and/or the substrate 122. The white ink 126 (in combination with a binder 127) can be applied to an article 114 while partially cured or fully cured. In some embodiments, the white ink 126 includes additives such as defoamers to reduce voids (e.g., bubbles) in the liquid ink. In some embodiments, no white ink 126 is disposed on the substrate 122 during the printing process, in particular for printing of white or light colored articles.

Suitable types of binding of the image 107 to the article 114 includes covalent bonding, intermolecular bonding, mechanical interlocking, or combinations thereof. In some embodiments, the binding of the image 107 to the article 114 is due to a heat triggered, melt-solidify process between the binder and the fibers of the fabric article 114.

The binder 127 can be a jettable adhesive or a powder adhesive to be disposed on the color ink printed layer 201 or the white ink printed layer 202. The binder 127 can be a liquid, an emulsion, a semi-solid, a gel, or a powder. The binder 127 serves as an adhesive to bind the image 107 to the article 114. The binder 127 can be applied to the article 114 while wet or not fully cured. The transfer of wet or not fully cured binder 127 can facilitate adhesion of the image 107 to the article 114. The wet or not fully cured binder 127 of the printed image 107 facilitates increased mobility of the ink into the article 114.

The use of “wet” or partially cured ink and/or binder can improve the efficiency of the printing process by decreasing the heat required to cure the ink and/or the binder.

The binder 127 can include polyolefin, polyamide, polyester, polyurethane, styrene butadiene copolymers, other thermoplastic adhesives, or combinations thereof. In some embodiments, the binder 127 is an aqueous polymer dispersion with the suitable viscosity for inkjet printing. In some embodiments, the binder 127 has a viscosity range of about 3 centipoise (cP) to about 20 cP, about 5 cP to 15 cP, or about 8 cP to 12 cP. In some embodiments, the binder can be applied with a piezoelectric inkjet printhead. In some embodiments, the binder 127 is heated above the melting point of the binder to facilitate printing of the binder 127. In some embodiments, the binder 127 has a melting point range of about 90° C. to about 170° C., about 100° C. to about 150° C., or about 110° C. to about 140° C. In some embodiments, the binder can be applied with a heated applicator 112, such as a thermal inkjet printhead. In some embodiments, the binder 127 is a liquid at ambient temperature with a melting point range of about 0° C. to about 30° C. In embodiments, where the binder 127 is liquid at ambient temperatures, the binder can be crosslinked with thermal, UV, and/or visible light during image transfer. The binder 127 can be added to the white ink printed layer 202 in a ratio of binder to ink of about 5:1 to about 1:5, about 4:1 to about 1:4, about 3:1 to about 1:3. In embodiments, where no white ink 126 is printed, the binder 127 can be added to the color ink printed layer 201 in a ratio of binder to ink of about 5:1 to about 1:5, about 4:1 to about 1:4, about 3:1 to about 1:3 (e.g., 3:2 to 3:4, or the like). The use of a liquid binder can provide improved hand feel for the transferred image (softer and smoother image) in comparison to images transferred with a powdered, hot melt resin adhesive (powder adhesive).

The first platen 113 and the second platen 115 can be any element capable of physically supporting the article 114 and/or the composition 200. In some embodiments the first platen 113 and the second platen 115 form a heat press. The transfer of the image 107 to the article 114 can be accompanied with heating. In some embodiments, the transfer of the image can be accompanied with UV irradiation, visible irradiation, or combinations thereof. The platens can be heated from about 100° C. to about 200° C. to facilitate the image transfer process.

At the transfer station 104, the image 107 can be disposed on the article 114. The image 107 can be transferred to the article 114 via heating, pressure, and/or other suitable treatment process. A transfer/curing process at the transfer station 104 can be performed for about 1 second to about 30 minutes, for about 30 seconds to about 20 minutes, for about 1 minute to about 10 minutes.

The article 114 to be printed can be pre-treated before the image 107 transferring. Suitable pre-treatments include pre-wash chemical treatments, heat pressing, and combinations thereof.

Article delivery methods to transport the article 114 to the transfer station 104 can include automated or manual delivery methods. Suitable article delivery systems include carousels, serpentine conveyors, and the like. In some embodiments, multiple platens 115 are present in the printing assembly 100 to facilitate the continuous transport of an article 114 to be printed to the transfer station 104. The use of multiple platens 115 can increase the speed and efficiency of printing multiple articles.

In an embodiment, fully automated printing of articles by one or more operator(s) can be undertaken with a printing assembly 100 as shown in FIG. 1. In some embodiments, the printing assembly includes a scanner, during the use of the assembly a label is scanned to provide electronic printing instructions before printing ink onto a substrate. The label can be disposed on an article 114 to be printed, a platen 115 the article 114 is or will be loaded on, or some other suitable location. In this manner, the automated assembly can begin the printing process based on the scanned instructions.

The printing method can include a substrate 122 to support the printed image 107. Color ink 109 can be disposed on the substrate 122. The color ink 109 can be partially or fully cured by the curing element 110. The substrate 122 and color ink printed layer 201 are then transported to the white ink printing station 102. White ink 126 can be printed on the color ink printed layer 201. The white ink 126 can be partially or fully cured by the curing element 123. The substrate 122, color ink printed layer 201, and the white ink printed layer 202 are then transported to the binder printing or spraying station 103. The binder 127 is disposed on the white ink printed layer 202. The binder 127 can be partially or fully cured by the curing elements 124. The substrate 122, the color ink printed layer 201, the white ink printed layer 202, and the binder layer 203 form the composition 200. The curing or partial curing of the ink layer(s) and the binder layer can provide i) a cured ink layer and a cured binder layer, ii) a partially cured ink layer and a partially cured binder layer, iii) a cured ink layer and a partially cured binder layer, or iv) a partially cured ink layer and a cured binder layer. In some embodiments, the cured ink layer can comprise a cured white ink layer and a partially cured color ink layer, a partially cured white ink layer and a partially cured color ink layer, a cured white ink layer and a cured color ink layer, or a partially cured white ink layer and a cured color ink layer with a cured binder layer or a partially cured binder layer.

In some embodiments, the composition 200 does not include one of the color ink printed layer 201 and the white ink printed layer 202.

After curing or partial curing, the composition 200 can be transported to a transfer station 104. The composition 200 can be disposed on the article 114 to be printed via an automated process, without cutting the composition 200 out around the edges of the image 107. In some embodiments, the composition 200 is disposed on a first platen 113. The article 114 to be printed is transported to the transfer station 104. In some embodiments, the article 114 can be delivered by a carousel or a serpentine conveyor system. The article 114 can be disposed on a second platen 115. In some embodiments, multiple platens 115 are present and another article 114 can be delivered continuously to the transfer station 104 (e.g., 2 platens, 3 platens, 4 platens, or the like, up to 20 platens). The composition 200 can be placed between the first platen 113 and the second platen 115 and onto the article 114 to be printed. The composition 200 is oriented where the binder layer 203 is disposed on the article 114. In some embodiments platen 113 and platen 115 are pressed together to heat press the image 107 onto the article 114. The transfer of the image 107 to the article 114 can be accompanied with heating, UV irradiation, visible irradiation, or combinations thereof. After transfer of the image 107 of the composition 200 onto the article 114, the substrate 122 is removed from the finished image 117 to provide the printed article 116.

The transferring of the image 107 to the article 114 can be performed when an ink or both inks, color and white, and the binder are wet or not fully cured. In this manner, wet or not fully cured inks and binder can improve the efficiency of the printing process by decreasing the heat required to cure the ink and/or the binder.

The materials and methods detailed herein are further exemplified by the following non-limiting examples.

### Examples

### Liquid Adhesive Application and Evaluation

Direct to film samples were evaluated by printing color and white ink layers onto DTF paper, followed by printing of liquid adhesive onto the printed ink layers. The conveyor cured the composition of DTF paper, inks, and liquid adhesive at 330° F. for 95 seconds. After curing of the composition, the images were transferred onto a fabric article with a heat press at 350° F. and 40 pounds per square inch (psi) of pressure for 30 seconds.

The materials used are listed in Table 1.

TABLE 1

| | |
|---|---|
| Material | White ink, CMYK ink, and liquid adhesive were |
| | produced from Eastern Tech Company. Direct to |
| | film transfer sheet was purchased from Brother |
| | Industries, Ltd. GTX pro B DTG printer was |
| | purchased from Brother Industries, LTD. 4720 DTG |
| | printer was purchased from Wuhan Kinglocor |
| | Technology CO., Ltd. LittleRed X3-D infrared dryer |
| | was purchased from VASTEX International, |
| | Inc. Hotronix Fusion IQ heat press was purchased |
| | from Stahls' Inc. |
| Ink | Firebird GTX pro B compatible white and CMYK |
| | ink set |
| Liquid Adhesive | Firebird 4720 compatible liquid adhesive |
| DTF paper | Direct to Film Transfer sheets, Brother |
| Printer | GTX pro B for ink printing, Brother |
| | 4720 printer for liquid adhesive printing, Wuhan |
| | Kinglocor Technology |
| Infrared Conveyor | 330° F. for 95 seconds |
| Setting for Curing | |
| the Ink and Liquid | |
| Adhesive | |
| Heat Press Setting | 350° F./40 psi/30 seconds |
| for Image Transfer | |

Table 2 provides the sample details for Examples 1 to 3. For each example, 0.9 grams of white ink was used. For a single pass of liquid adhesive, 0.33 grams of adhesive were disposed on the printed ink layers.

TABLE 2

| Exam- | White ink to liquid adhesive | |
|---|---|---|
| ple | ratio | Observations |
| 1 | 3:1 (one pass of liquid adhesive) | |
| 2 | 3:2 (two passes of liquid | Superior image transfer in |
| | adhesive) | comparison to Example 1. |
| 3 | 3:4 (four passes of liquid | Superior image transfer in |
| | adhesive) | comparison to Example 1. |
| | | Superior wash performance in |
| | | comparison to Examples 2 |
| | | and 3 (images lasted for |
| | | at least 10 washes*). |

*Front Loading Washer with 2 kilograms load, 40 grams of detergent, normal wash program.

As noted in Table 2, additional liquid adhesive for Examples 2 and 3 provided superior image transfer (easier removal of the used substrate from the transferred image, macroscopic observations of increased image clarity and more saturated color). Use of more liquid adhesive, such as in Example 3, provided superior washability for image retention in comparison to Examples 1 and 2. All of the Examples provided better hand feel for the transferred image (softer and smoother) in comparison to images transferred with a powdered, hot melt resin adhesive. It is of note, that the curing conditions of 330° F. for 95 seconds were insufficient to fully dry the liquid adhesive before transfer of the image.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A direct-to-substrate printing assembly comprising:
a substrate;
an ink printing station, wherein the ink printing station is configured to print an ink layer onto the substrate;
a binder application station, wherein the binder application station is configured to dispose a binder onto the ink layer;
a curing station, wherein the curing station is configured to cure or partially cure the ink layer and binder layer to provide a cured ink and binder layer or a partially cured ink and binder layer; and
a transfer station, wherein the transfer station is configured to transfer the cured ink and the binder layer or the partially cured ink and binder layer disposed on the substrate to an article;
wherein the assembly is fully automated.

2. The assembly of claim 1, wherein the binder is a jettable liquid or a powder adhesive and the binder application station is configured to dispose the jettable liquid or the powder adhesive onto the ink layer.

3. The assembly of claim 1, wherein the substrate is a roll or a sheet.

4. The assembly of claim 1, further comprising a carousel or serpentine conveyor configured to transfer an article to the transfer station.

5. The assembly of claim 1, further comprising multiple platens.

6. The assembly of claim 1, further comprising a scanner configured to intake print job data.

7. A method of direct to substrate printing comprising:
printing an ink onto a substrate to form an ink layer;
disposing a binder onto the ink layer,
wherein the substrate with the ink layer and the binder layer forms a composition; curing or partially curing the ink layer and binder layer to provide i) a cured ink layer and a cured binder layer, ii) a partially cured ink layer and a partially cured binder layer, iii) a cured ink layer and a partially cured binder layer, or iv) a partially cured ink layer and a cured binder layer;
orienting the partially cured binder layer or the cured binder layer of the composition to face towards an article to be printed and disposing the composition onto the article to be printed;
transferring the partially cured ink layer or the cured ink layer and the partially cured binder layer or the cured binder layer onto the article to be printed to provide a printed article; and
removing the substrate from the printed article,
wherein the substrate is transported automatically throughout the method.

8. The method of claim 7, wherein a single operator performs the method.

9. The method of claim 7, wherein the substrate is on a digital printing carousel to convey the substrate.

10. The method of claim 7, wherein the binder is a jettable liquid or powder adhesive and the binder is printed or sprayed onto the ink layer.

11. The method of claim 7, wherein the ink layer printed on the substrate is fully cured before transferring the cured ink layer to the article.

12. The method of claim 7, wherein the binder layer disposed on the ink layer is fully cured before transferring the cured binder layer to the article.

13. The method of claim 7, wherein the curing or the partially curing of the ink layer and/or the binder layer is performed at a temperature greater than ambient temperature with direct or indirect infrared irradiation, ultraviolet irradiation, visible light irradiation, laser heat treatment, or a combination thereof.

14. The method of claim 13, wherein the curing or the partially curing of the ink layer and/or the binder layer is performed with crosslinking.

15. The method of claim 7, wherein the transferring the partially cured ink layer or the cured ink layer and the partially cured binder layer or the cured binder layer is performed with a heat press.

16. The method of claim 15, wherein the transferring the partially cured ink layer or the cured ink layer and the partially cured binder layer or the cured binder layer is also performed with crosslinking.

17. The method of claim 7, further comprising scanning a label to provide printing job data before the printing the ink onto the substrate.

18. A transferable image composition for direct to substrate printing comprising:
a substrate;
a printed ink layer comprising an image to be printed on an article; and
a binder layer comprising a jettable binder or a powder adhesive disposed on the printed ink layer.

19. The transferable image composition of claim 18, wherein the printed ink layer and/or the binder layer are fully cured or partially cured before transfer of the image to an article.

20. The transferable image composition of claim 18, wherein the substrate is a sheet of film, a sheet of paper, a roll of film, or a roll of paper.
